(19) United States
(12) Patent Application Publication
(10) Pub. No.: US 2003/0031173 A1
(43) Pub. Date: Feb. 13, 2003

(54) Multilayer internet protocol (MLIP) for peer-to-peer service of private internet and method for transmitting/receiving MLIP packet

(76) Inventors: Chang-min Park, Daejon (KR); Mi-ryong Park, Daejon (KR); Jong-hyup Lee, Daejon (KR); Hyeong-ho Lee, Daejon (KR); Gui-soon Park, Daejon (KR); Sang-ha Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/213,887

(22) Filed: Aug. 6, 2002

(30) Foreign Application Priority Data
Aug. 9, 2001 (KR) 2001-47949

(51) Int. Cl. H04L 12/28

(52) U.S. Cl. 370/389; 370/401

(57) ABSTRACT

Provided is a Multi-layer Internet Protocol (MLIP) for peer-to-peer service of a private Internet and a method for transmitting/receiving a MLIP packet through IPv4 backbone network. The Multi-layer Internet Protocol (MLIP) packet comprises a source address field for saving a public Internet address of the source; a destination address field for saving a public Internet address of the destination; and an option field including, an option class field for saving data indicating that the information on a private Internet address is saved in the option field; an option length field for saving data on the length of the private Internet address information; a source sub-address field for saving the private Internet address information of the source; and a destination sub-address field for saving the private Internet address information of the destination. According to the MLIP and the method for transmitting/receiving the MLIP packet, addresses are expanded according to IPv4 within the private Internet without impacting on the internal router in the existing Internet. Therefore, an IPv4 router need not be replaced. All the access networks use the currently-defined private Internet addresses including one A class, 16 B classes and 255 C classes, providing peer-to-peer services between private Internet.

### BACKGROUND OF THE INVENTION

1. Field of the Invention

The present invention relates to network communication using Transmission Control Protocol (TCP)/Internet Protocol version 4 (IPv4), and more particularly, to Multi Layer Internet Protocol (MLIP) for peer-to-peer service of a private Internet and a method for transmitting/receiving a MLIP packet.

2. Description of the Related Art

In RFC791 Internet protocol, it is recommended that Internet Protocol version 4 (IPv4) made up of a 4-byte address be used for an Internet address. However, as the number of Internet users and IMT-2000-based mobile terminal users increase explosively, IPv4 addressing is limited in its ability to assign sufficient number of addresses to satisfy all those who want to enjoy the Internet services. Solutions to the insufficient addresses include Classless Inter-Domain Routing (CIDR) which adds a detailed class definition to the IPv4 addressing, Network Address Transition (NAT) which utilizes an independent address system in a sub-network (private Internet), or Dynamic Host Configuration Protocol (DHCP) which features dynamic assignment of Internet addresses.

However, the above solutions cannot be the final answers to the above problems. The CIDR makes a routing table complicated. As for NAT, a server which has to convert the addresses of the IP header may experience delay in the conversion, and because one side terminal using the method of the NAT cannot be accessed by the opposite terminal, only one-way service can be provided. In addition, since DHCP does not guarantee that the Internet address assigned before the service disconnection is assigned again after reconnection, it cannot assign a unique address.

As a fundamental solution to the above problems, IPv6 enables 16-byte addresses to be assigned for the Internet. IPv6 has a competitive edge the IPv4 addressing in that it can secure addresses sufficient enough to accommodate all services in the near future. However, IPv6 network, which is totally different from the existing IPv4 Internet, necessitates a new IPv6 router and a way of working with the existing IPv4 Internet.

### SUMMARY OF THE INVENTION

To solve the above-described problems, it is an object of the present invention to provide a Multi-Layer Internet Protocol (MLIP) packet for peer-to-peer service of a private Internet.

It is another object of the present invention to provide a method for transmitting/receiving the MLIP packet through IPv4 backbone network.

To achieve the first objective, it is preferred that a Multi Layer Internet Protocol (MLIP) packet according to the present invention has a header which includes: a source address field for saving a public Internet address of the source; a destination address field for saving a public Internet address of the destination; and an option field for including: an option class field for saving data indicating that the information on a private Internet address is saved in the option field; an option length field for saving data on the length of the private Internet address information; a source sub-address field for saving the private Internet address information of the source; and a destination sub-address field for saving the private Internet address information of the destination.

To achieve the second objective, the method for transmitting the MLIP packet which has a header with a source address field, a destination address field, and an option field including a source sub-address field and a destination sub-address field for saving the private Internet addresses of the source and the destination, respectively, according to the present invention, comprises: (a) a step of saving the public Internet address and the private Internet address of the destination in the destination address field and the destination sub-address field respectively; (b) a step of saving the public Internet address and the private Internet address of the source in the source address field and the source sub-address field respectively; (c) a step of comparing the public Internet address of the source and the public Internet address of the destination and, if the two addresses are the same, exchanging the address data saved in the destination address field with the address data saved in the destination sub-address field; and (d) a step of exchanging the address data saved in the source address field with the address saved in the source sub-address field, if the public Internet addresses of the source and the destination are not the same or after (c) step.

To achieve the third objective, the method for receiving the MLIP packet which has a header with a source address field, a destination address field, and an option field including a source sub-address field and a destination sub-address field, according to the present invention, comprises: (a) a step of judging whether the address in the destination sub-address field is the same as the public Internet address of the receiving point if the address of the destination address field is the same as the private Internet address of the receiving point, and discarding the received packet unless the address in the destination sub-address field is the same as the public Internet address of the receiving point; (b) a step of exchanging the address information in the destination address field with the address information in the destination sub-address field if the address in the destination sub-address field determined to be the same as the public Internet address of the receiving point in step (a), and processing packets depending on a pre-defined packet format; (c) a step of judging whether the address in the source address field is the private Internet address unless the address in the destination address field is determined to be the private Internet address of the receiving point in step (a) ; (d) a step of performing a pre-defined address processing depending on whether the address in the source sub-address field is the public Internet address of the receiving point when the address in the source address field is determined to be the private Internet address in step (c), and forwarding the received packet to the public Internet; and (e) a step of judging whether the address in the destination address field is the public Internet address of the receiving point and whether the address of the destination sub-address field is the private Internet address unless the address in the source address field is the private Internet address at (d) step, performing a packet processing in a pre-defined packet format or address processing depending on the judgment result, and forwarding the received packet to the public Internet.

### BRIEF DESCRIPTION OF THE DRAWINGS

The above object and advantages of the present invention will become more apparent by describing in detail the preferred embodiments thereof with reference to the attached drawings in which:

FIG. 1 is a block diagram showing an Internet service network;

FIG. 2 shows public Internet addresses used in RFC791 Internet protocol;

FIG. 3 shows private Internet addresses;

FIG. 4 shows the format of an IP packet;

FIG. 5 shows the structure of the options field of the IP packet shown in FIG. 4, according to the present invention;

FIG. 6 shows the packet configuration of Multi-Layer Internet Protocol (MLIP) according to the present invention, using the options field information shown in FIG. 5;

FIG. 7 is a block diagram showing devices for processing the MLIP packet according to the present invention;

FIG. 8 is a flow chart showing one embodiment of the reception method of the MLIP packet shown in FIG. 6;

FIG. 9 is a flow chart showing one embodiment of the reception and the processing methods of the MLIP packet shown in FIG. 6; and

FIG. 10 is a table showing the result of the comparison of the service compatibility of the existing Internet protocol with the MLIP according to the present invention.

### DETAILED DESCRIPTION OF THE INVENTION

MLIP protocol for peer-to-peer service for a private Internet and a method for transmitting/receiving a MLIP protocol packet through IPv4 backbone network according to the present invention will hereinafter be described with reference to the accompanying drawings.

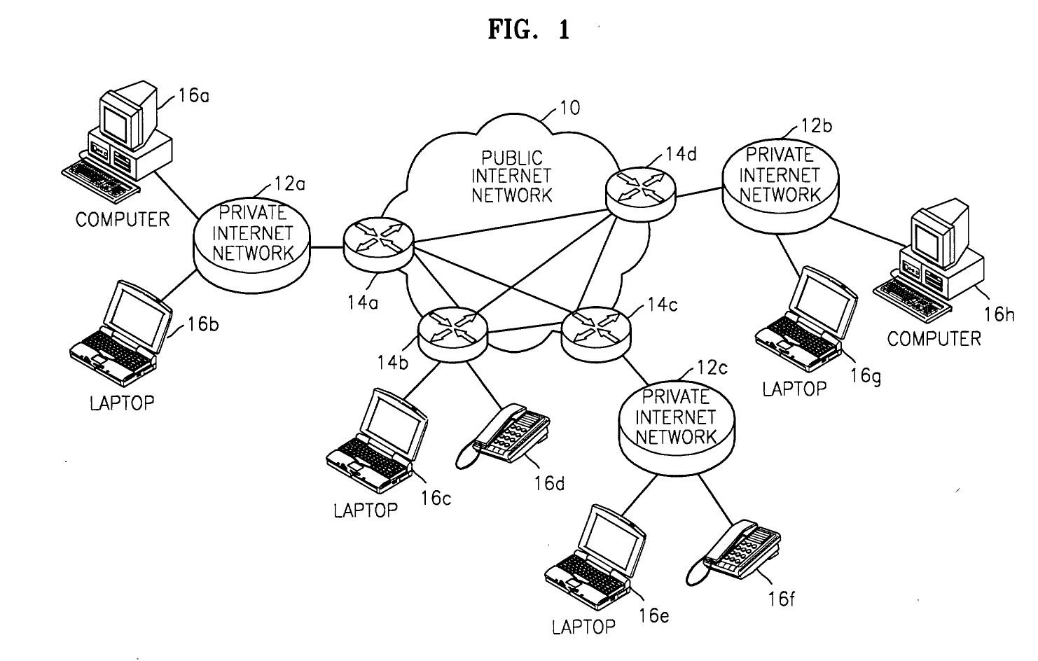

FIG. 1 is a block diagram of an Internet service network. As shown in FIG. 1, the Internet service network may consist only of a public Internet 10. However, as the NAT protocol develops, private Internets 12a, 12b, 12c using private Internet addresses can co-exist with the public Internet 10. When the private Internets 12a, 12b, 12c are used, each of the private Internets 12a, 12b, 12c can access data provided by the public Internet 10. In addition, it is able to access service data in each private Internet. However, direct service access from the public Internet 10 or to the private Internet 12a, 12b, 12c cannot be supported. In addition, direct service access between the private Internets 12a, 12b, 12c cannot be supported. That is, as shown in FIG. 1, when the private Internets are used, only one-way access from each of the private Internet network 12a, 12b, 12c to the public Internet 10 is allowed.

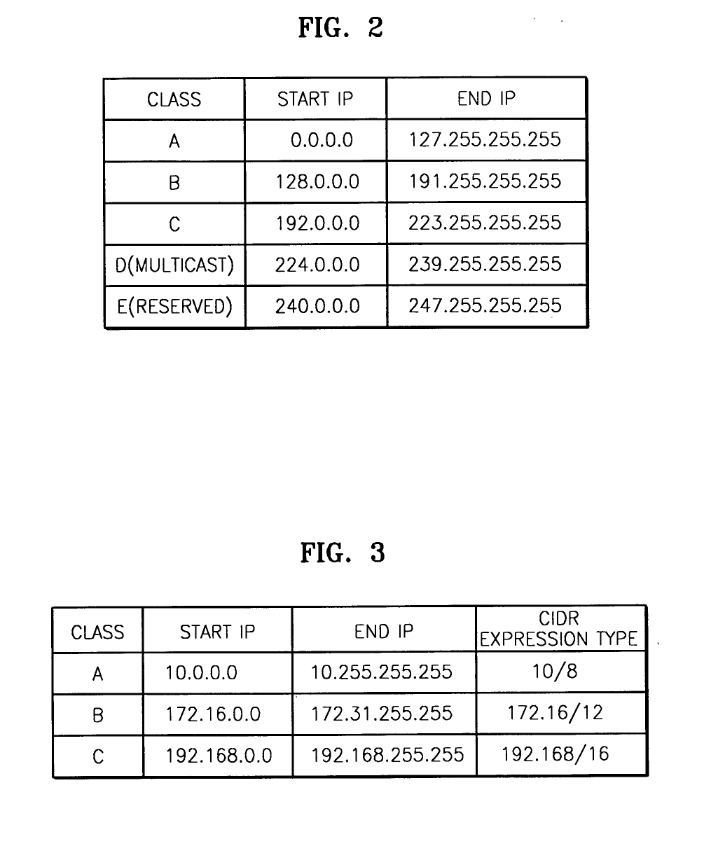

FIG. 2 shows public Internet addresses used in the RFC791 Internet protocol.

With reference to FIG. 2, public Internet addresses are divided into 5 hierarchical classes: A, B, C, D and E. Class D is used for multicasting addresses, and class E is reserved for future use. Each class has a start IP and an end IP as shown in FIG. 2.

FIG. 3 shows private Internet addresses. A private Internet is used for the expansion of public Internet addresses.

In FIG. 3, private Internet addresses are divided into 3 classes: A, B and C. Each class has a start IP and an end IP. Each class also has a Classless InterDomain Routing (CIDR) indication format (masking value). Only the private Internet can use the addresses with the above-described format. The public Internet cannot use the above addresses.

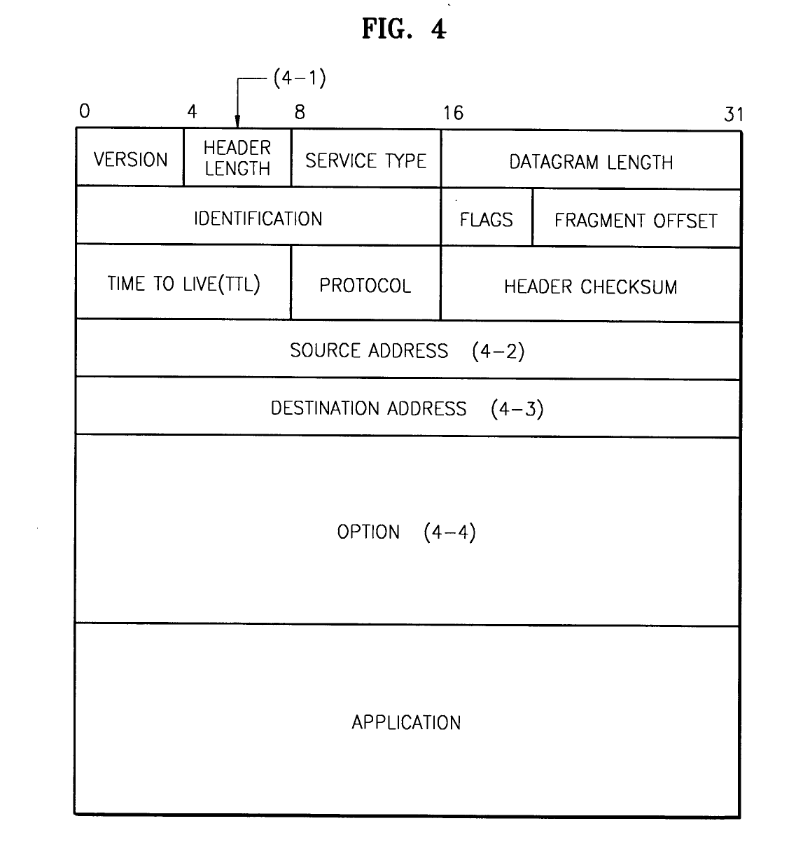

FIG. 4 shows a general IP packet format. With reference to FIG. 4, an IP packet includes a version number field, a header length field 4-1, a service type field, a datagram length field, an identifier field, a flag field, a fragment offset field, a time to live field, a protocol field, a header checksum field, a source address field, a destination address field, an option field 4-4 and an application field. In the application field, the data to be transmitted is assigned and the option field 4-4 is included in the header. As for the maximum header length, because the header length 4-1 is 4 bits, the maximum length is 60 bytes (4*15=60). The Internet addresses defined in FIG. 2 or FIG. 3 are assigned as the source address and the destination address, respectively. The option field 4-4 can have up to 40 bytes except for the 20-byte default field of the header. According to the present invention, in the option field 4-4 of the IP header, the public Internet addresses and the private Internet addresses are assigned, and direct services between private Internets can be provided.

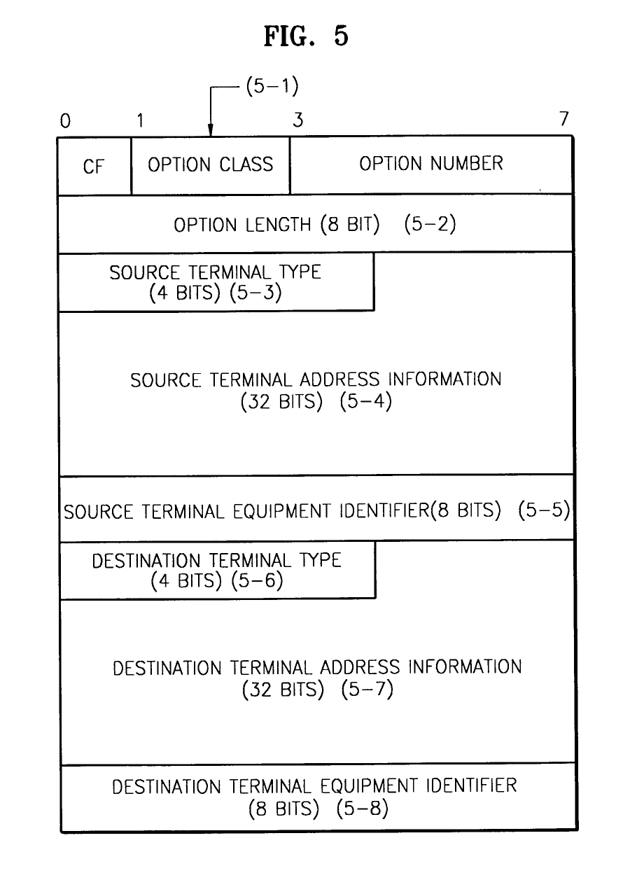

FIG. 5 shows the structure of the option field 4-4 of the IP packet shown in FIG. 4 according to the present invention.

With reference to FIG. 5, new information (private Internet address of the transmitting/receiving terminal) in the first octet of the option field 4-4 is defined as an option class 5-1. That is, the option class 5-1 indicates whether the private Internet is defined in the option field or not. An option length field 52 stores the data on the length of the address information. A source terminal type field 5-3 stores the information indicative of the source terminal type, which may include an Internet terminal, a mobile handset, a VolP service terminal, an information appliance product, etc. The source terminal address information field 5-4 stores the private Internet address information. The terminal equipment identifier field 5-5 stores information for identifying various terminals which share the same private Internet addresses in the home network. In addition, the option field 4-4 includes a source terminal type field 56, a destination terminal address information (private Internet address information) field 5-7, and a destination terminal identifier field 5-8. As shown above, the private Internet address information is saved in the option field and the public Internet address is saved in the basic header area. That is, the public Internet addresses and the private Internet addresses assigned to one Internet Protocol (IP) allow direct service access between private Internets.

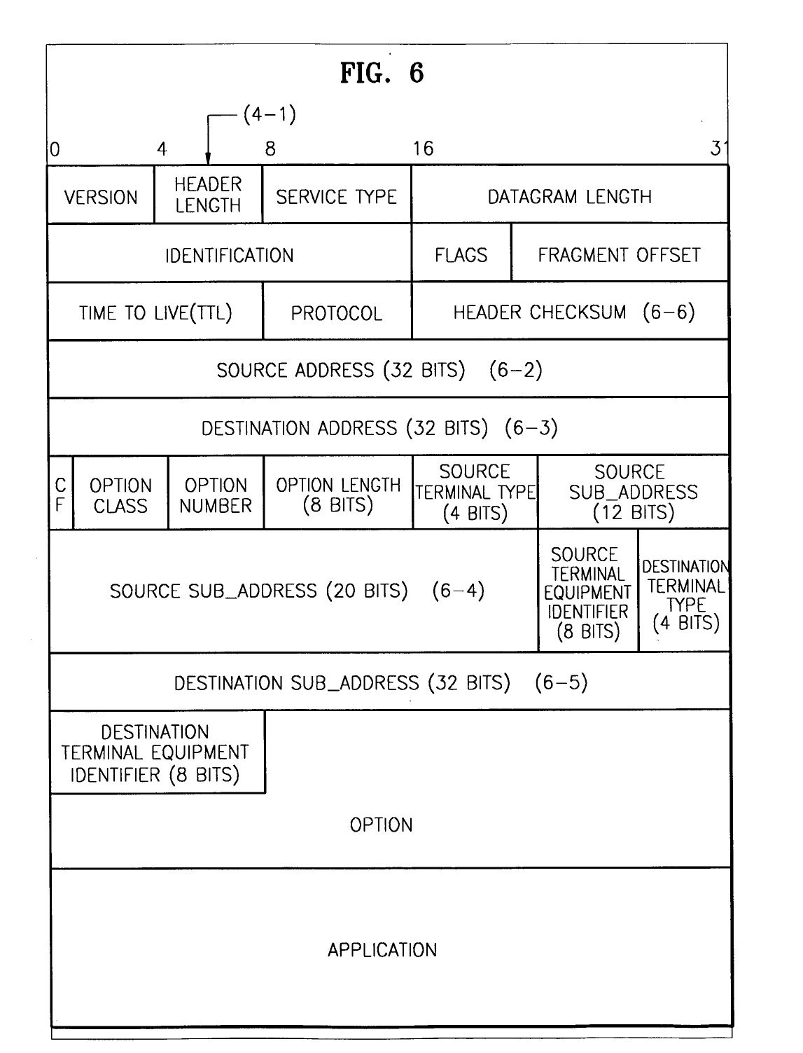

FIG. 6 shows the packet configuration of a Multi Layer Internet Protocol (MLIP) according to the present invention, using the option field information shown in FIG. 5.

As shown in FIG. 6, the header length field 4-1, a source address field 6-2 and a destination address field 6-3 store the information on the header length, the public Internet address of the source, and the public Internet address of the destination, respectively. The private Internet address of the source and the private Internet address of the destination are stored in a source sub-address field (32bit) 6-4 and a destination sub-address field (32bit) 6-5, respectively. As described below, the field information of the address is changed by the MLIP processing according to the present invention.

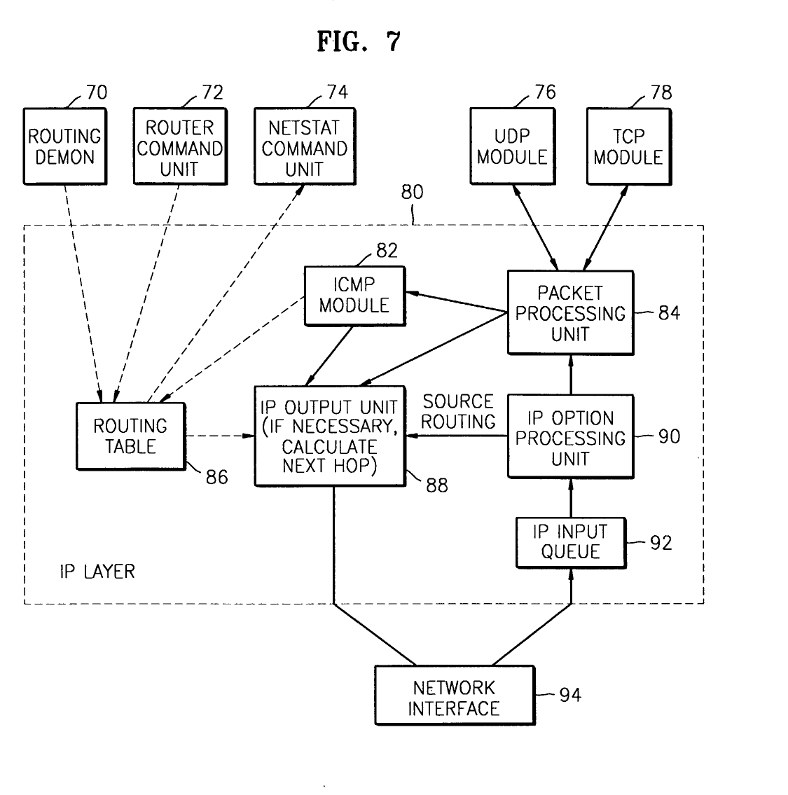

FIG. 7 is a block diagram showing device for processing the MLIP packet according to the present invention. The processing devices include a routing demon 70, a router command unit 72, a netstat command unit 74, a User Datagram Protocol (UDP) module 76, a TCP module 78, an IP processing unit 80, and a network interface 94. In addition, the IP processing unit 80 includes a routing table 86, an IP output unit 88, an IP option processing unit 90, an IP input queue 92, a packet processing unit 84, and an ICMP module 82.

The MLIP packet processing device shown in FIG. 7 is the same as the existing IP packet processing device except that the IP option processing unit 90 is added. That is, the basic functions of the existing IP packet processing units are used without affecting the existing IP packet processing services. The option processing unit 90 is added to process the newly added information in the option field shown in FIG. 6.

In FIG. 7, the control information route for modifying the routing information of the routing table 86 is indicated as a dotted line. The packet transmitted by the network interface 94, which is a link layer, is inputted to the IP input queue 92. Then, the IP input queue 92 processes the source routing depending on the existing IP option processing function. The IP option processing unit 90 processes the MLIP packet. If the received packet is not a MLIP packet, the IP option processing unit 90 transmits the received packet to the packet processing unit 84, and the packet processing unit 84 transmits the packet to the UDP module 76, the TCP module 78, or the ICMP module 82 depending on the received packet type. The commands and the processing procedures of units 70, 72, 74, 82, 88 for modifying the information of the routing table 86 in FIG. 7 are the same as those of existing technology.

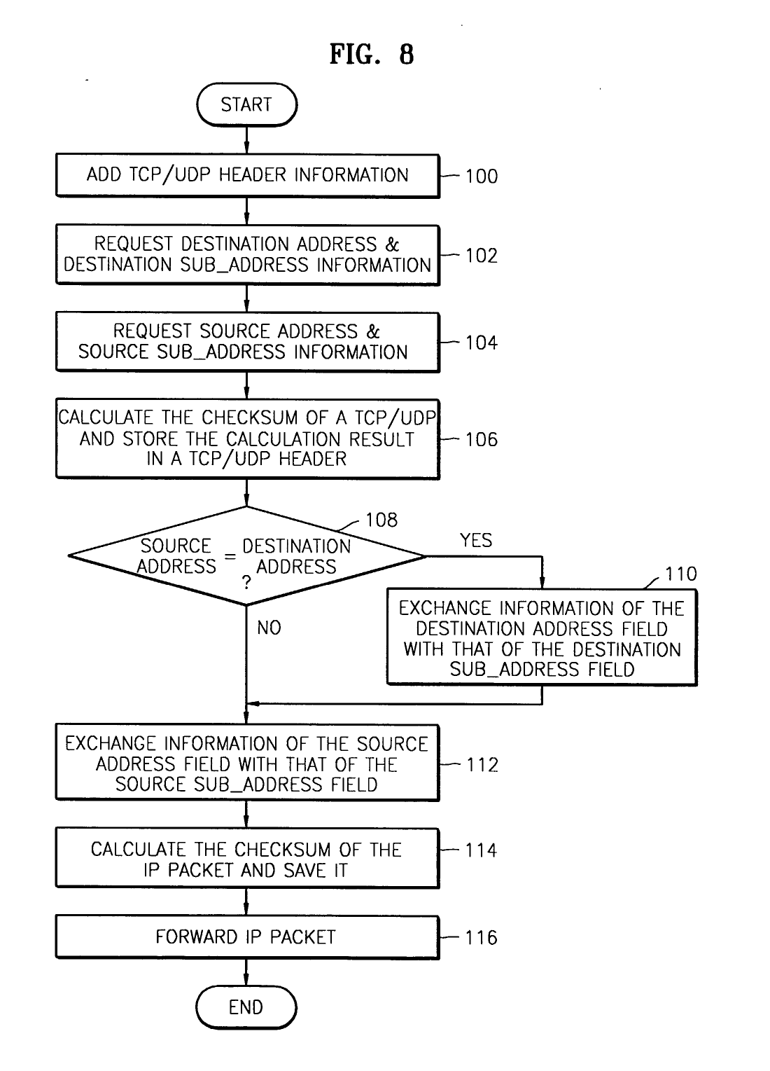

FIG. 8 is a flow diagram showing one embodiment of the transmission method of the MLIP packet shown in FIG. 6.

As shown in FIGS. 6 and 8, in step 100, the MLIP-compliant system adds the header information to the TCP/UDP payload (application field, see FIG. 6) in order to transmit the application service data. Then, in step 102, the system enters the public Internet address and the private Internet address of the destination into the destination address field 6-3 and the destination sub-address field 6-5 respectively, or receives the public Internet address and the private Internet address of the destination from the Domain Name Server (DNS) (not shown) and saves them in the relevant fields respectively. In step 104, the system stores the public Internet address and the private Internet address of the source in the source address field 6-2 and the source sub-address field 6-4, respectively.

In step 106, the system calculates the checksum of a TCP/UDP header using the public Internet addresses (shown in steps 102 and 104) of the source and the destination, and stores the calculated result in a TCP/UDP header checksum field (included in the application field).

In step 108, the system compares the public Internet address of the source saved in the source address field 6-2 with the public Internet address of the destination saved in the destination address field 6-3. If the public Internet address of the source is determined to be the same as that of the destination in step 108, it means the service in the private Internet. In step 110, the system exchanges the information of the destination address field 6-3 with that of the destination sub-address field 6-5. Therefore, the private Internet address is saved in the destination address field 6-3, and the public Internet address of the destination is saved in the destination sub-address field 6-5.

If the public Internet address of the source is determined to be different from the destination in step 108 or after step 110, the system exchanges the information of the source address field 6-2 with that of the source sub-address field 6-4 in step 112. Therefore, the private Internet address of the source is saved in the source address field 6-2 and the public Internet address of the source is saved in the source sub-address field 6-4. As described above, since the private Internet address and the public Internet address are exchanged and saved, the ARP function is supported in the private Internet.

In step 114, the system calculates the checksum of the IP packet header information and saves it in the header checksum field 6-6. Then, in step 116, the system forwards the IP packet to the private Internet.

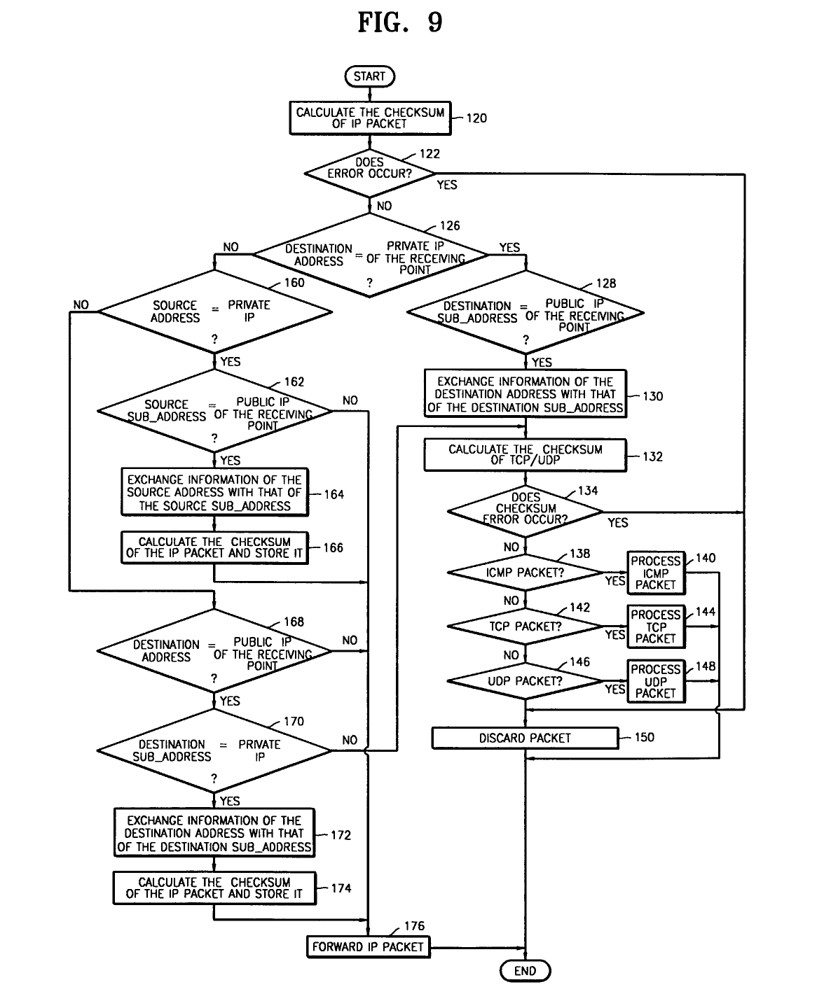

FIG. 9 is a flow diagram showing one embodiment of the reception and the processing methods of the MLIP packet shown in FIG. 6. Here, a received MLIP packet refuses to an IP packet whose address is processed for transmission according to the flow diagram shown in FIG. 8.

As shown in FIGS. 6 and 9, the MLIP-compliant system calculates the checksum of the received IP packet header information in step 120. In step 122, the system determines whether the received packet contains any errors based on the checksum calculation result. In step 124, the system discards the received packet if an error is present.

If the received packet is determined not to contain an error in step 122, the system compares the address of the destination address field 6-3 with the private Internet address of the receiving point that receives the IP packet in step 126. If the two addresses are the same, the system compares the private Internet address of the destination with the public Internet address of the receiving point in step 128. If the private Internet address of the destination is determined to be different from the public Internet address of the receiving point in step 128, the system discards the received packet in step 150.

If the private Internet address of the receiving point is determined to be the same as the public Internet address of the destination in step 128, it means the service within the private Internet. Subsequently, the system exchanges the information of the destination address field with that of the destination sub-address field and performs packet processing depending on a pre-defined packet format. To be more specific, the system exchanges the information of the destination address field 6-3 with that of the destination sub-address field 65 within the received packet in step 130. With regard to the IP packet transmitted according to the transmission method of FIG. 8, the private Internet address of the destination is saved in the destination address field 6-3 and the public Internet address is saved in the destination sub-address field 6-5. Therefore, in step 130, the system returns the packet to its original status by exchanging the address of the destination address field with that of the destination sub-address field. That is, the public Internet address is saved in the destination address field 6-3 and the private Internet address is saved in the destination sub-address field 6-5. In step 132, the system calculates the TCP/UDP checksum. In step 134, the system judges whether an error occurred using the checksum calculated result in step 132. If an error occurs, the system discards the received packet in step 150. If no error was found in step 134 and the received packet is determined to be ICMP packet in step 138, the system performs ICMP packet processing in step 140. If the received packet is determined to be a TCP packet in step 142, the system performs TCP packet processing in step 144. If the received packet is determined to be a UDP packet in step 146, the system performs UDP packet processing in step 148. If the packet type is neither ICMP, TCP nor UDP, the system discards the received packet in step 150.

If the address of the destination address field 6-3 is not the private Internet address of the receiving point in step 126, the system judges whether the source address is the private Internet address in step 160.

If the address of the source address field is determined to be the private Internet address in step 160, the system performs a pre-defined address processing depending on whether the address of the source sub-address field 6-2 is the public Internet address of the receiving point. Then, the system forwards the received packet to the public Internet. To be more specific, in step 162, the system judges whether the address of the source sub-address field 64 is the public Internet address of the receiving point. If the address of the source sub-address field 6-4 is not the same as the public Internet address of the receiving point, the system forwards the received IP packet to the public Internet in step 176. If the address of the source sub-address field 6-4 is the same as the public Internet address of the receiving point, the system exchanges the address of the source address field 6-2 with that of the source sub-address field 6-4 in step 164. In step 176, the system saves the calculation result in the header checksum field 6-6 after calculating the IP checksum in step 166, and forwards the IP packet to the public Internet in step 176.

If the address of the source address field 6-2 is determined not to be the private Internet address in step 160, the system judges whether the address of the destination address field 6-3 is the public Internet address of the receiving point, and whether the address of the destination sub-address field 65 is the private Internet address. Then, the system performs a packet processing depending on the judgement result. To be more specific, if the address of the source address field 6-2 is not the private Internet address, the system judges whether the address of the destination address field 6-3 is the same as the public Internet address of the receiving point. If they are not the same, the system forwards the received IP packet to the public Internet in step 168. If the address of the destination address field 6-3 is the same as the public Internet address of the receiving point, the system judges whether the address of the destination sub-address field 6-5 is the same as the private Internet address. If they are not the same, the system judges that the service is within the private Internet and goes to step 132 in step 170. If the address of the destination sub-address field 6-5 is determined to be the private Internet address in step 170, the system exchanges the address of the destination address field 6-3 with that of the destination sub-address field 6-5 in step 172. The system calculates the IP checksum and saves it in the header checksum field 6-6 in step 174. Then, the system forwards the IP packet to the public Internet in step 176.

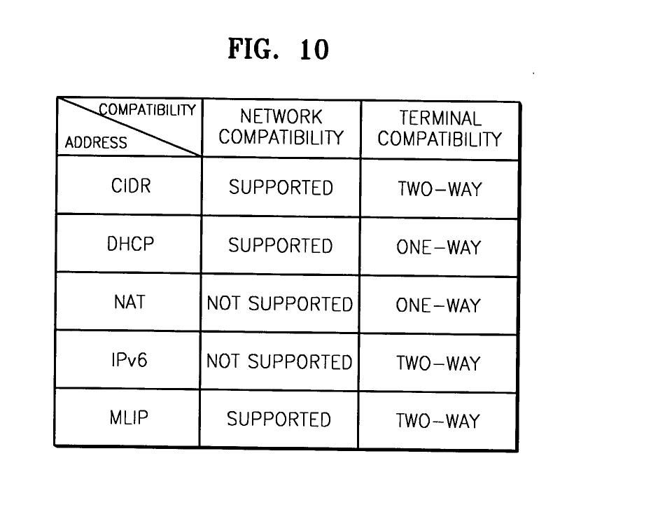

FIG. 10 is a table showing the result of the comparison of the service compatibility of the existing Internet protocol and the MLIP according to the present invention.

As shown in FIG. 10, service compatibility is divided into network compatibility and terminal compatibility. Only CIDR, DHCP, and MLIP which use the same address format can provide network compatibility. The NAT can provide services only within the private network using the private Internet. Since IPv6 uses 16-byte address formats, it cannot provide network compatibility.

From the perspective of the terminal service compatibility, the DHCP providing the dynamic address assignment cannot guarantee the consistent addresses. Because the NAT cannot provide the network compatibility, it supports only one-way service.

As a result, as shown in FIG. 10, only CIDR and MLIP can support two-way terminal compatibility and network compatibility. However, as described above, CIDR complicates the routing table. According to the present invention, MLIP defines the public Internet address and the private Internet address in the option field of the IP header, which is not used in the existing technology, and supports network compatibility and two-way terminal compatibility without affecting the existing routing table. Therefore, addresses can be expanded irrespective of services, and there is no need to implement a Session Initiation Protocol (SIP) proxy server and a Voice over Internet Protocol (VoIP) gate keeper used in existing two-way Internet communication services.

The present invention can be implemented as a computer-readable code on a computer-readable recording media. The computer-readable recording media may include all types of recording devices, such as ROM, RAM, CD-ROM, a magnetic tape, a floppy disc, and an optical data storing device, where the computer-readable data is saved. In addition, the present invention can be implemented in the form of a carrier wave, for example, for transmission over the Internet. The computer-readable recording media are distributed to the computer systems connected in a network, and the computer-readable codes are saved and executed in the distributed method.

Although specific embodiments of the invention have been described herein for illustrative purposes, various modifications can be made without departing from the spirit and scope of the invention, as recognized by those skilled in the relevant art. Accordingly, the invention is not limited to the disclosure, but instead its scope is to be determined entirely by the following claims.

As described above, according to the MLIP and the method for transmitting/receiving the MLIP packet, addresses are expanded according to IPv4 within the private Internet without impacting on the internal router in the existing Internet. Therefore, an IPv4 router need not be replaced. All the access networks use the currently-defined private Internet addresses including one A class, 16 B classes and 255 C classes, providing peer-to-peer services between private Internets.

What is claimed is:

1. A Multi-Layer Internet Protocol (MLIP) packet, comprising:
a source address field for saving a public Internet address of the source;
a destination address field for saving a public Internet address of the destination; and
an option field comprising:
an option class field for saving data indicating that the information on a private Internet address is saved in the option field;
an option length field for saving data on the length of the private Internet address information;
a source sub-address field for saving the private Internet address information of the source; and
a destination sub-address field for saving the private Internet address information of the destination.

2. The MLIP packet of claim 1, wherein the option field further comprises:
a first terminal type field and a second terminal type field for storing the source terminal type information and the destination terminal type information, respectively; and
a first terminal identifier field and a second terminal identifier field for storing the source terminal identification information and the destination terminal identification information, respectively.

3. A method for transmitting a Multi Layer Internet Protocol (MLIP) packet having a header with a source address field, a destination address field, and an option field including a source sub-address field and a destination sub-address field for saving the private Internet addresses of the source and the destination, respectively, the method comprising:
(a) a step of saving the public Internet address and the private Internet address of the destination in the destination address field and the destination sub-address field, respectively;
(b) a step of saving the public Internet address and the private Internet address of the source in the source address field and the source sub-address field, respectively;
(c) a step of comparing the public Internet address of the source with the public Internet address of the destination and, if the two addresses are the same, exchanging the address data saved in the destination address field with the address data saved in the destination sub-address field; and
(d) a step of exchanging the address data saved in the source address field with the address data saved in the source sub-address field if the public Internet addresses of the source and that of the destination are not the same or after (c) step.

4. The method of claim 3, wherein the public Internet address and the private Internet address of the destination are received from a Domain Name Server (DNS).

5. A method for receiving a Multi Layer Internet Protocol (MLIP) packet having a header with a source address field, a destination address field, and an option field including a source sub-address field and a destination sub-address field, the method comprising:
(a) a step of judging whether the address in the destination sub-address field is the same as the public Internet address of the receiving point if the address of the destination address field is the same as the private Internet address of the receiving point, and discarding the received packet unless the address in the destination sub-address field is the same as the public Internet address of the receiving point;
(b) a step of exchanging the address information in the destination address field with the address information in the destination sub-address field if the address in the destination sub-address field is determined to be the same as the public Internet address of the receiving point in step (a), and processing packets depending on a pre-defined packet format;
(c) a step of judging whether the address in the source address field is the private Internet address unless the address in the destination address field is determined to be the private Internet address of the receiving point in step (a);
(d) a step of performing a pre-defined address processing depending on whether the address in the source sub-address field is the public Internet address of the receiving point when the address in the source address field is determined to be the private Internet address in step (c), and forwarding the received packet to the public Internet; and
(e) a step of judging whether the address in the destination address field is the public Internet address of the receiving point and whether the address of the destination sub-address field is the private Internet address of the receiving point unless the address in the source address field is determined to be the private Internet address in step (d), performing a packet processing in a pre-defined packet format or address processing depending on the judgement result, and forwarding the received packet to the public Internet.

6. The method of claim 5, before step (a), further comprising;
a step of calculating the checksum if the MLIP is received and judging whether an error occurs; and
a step of discarding the received packet if an error occurs.

7. The method of claim 5, wherein step (b) comprises:
(b1) a step of exchanging the address of the destination address field with that of the destination sub-address field if the address of the destination sub-address field is determined to be the same as that of the public Internet address of the receiving point in step (a);
(b2) a step of performing ICMP packet processing if an ICMP packet is received;
(b3) a step of performing TCP packet processing if a TCP packet is received;
(b4) a step of performing UDP packet processing if a UDP packet is received; and
(b5) a step of discarding the received packet if the packet type is not one of ICMP, TCP and UDP.

8. The method of claim 7, after step (b1), further comprising;
a step of calculating the TCP/UDP checksum, judging whether a checksum error occurs, and discarding the received packet if an error occurs.

9. The method of claim 5, wherein step (d) comprises:
(d1) a step of forwarding the received packet to the public Internet if the address of the source sub-address field is not the same as the public Internet address of the receiving point;
(d2) a step of exchanging the address of the source address field with the address of the sub-address field if the address of the source sub-address field is the same as the public Internet address of the receiving point; and
(d3) a step of calculating the Internet protocol checksum, storing the calculation result, and forwarding the received packet to the public Internet.

10. The method of claim 5, wherein step (e) comprises:
(e1) a step of judging whether the address of the destination address field is the same as the public Internet address of the receiving point and forwarding the received packet to the public Internet if the two addresses are not the same;
(e2) a step of judging whether the address of the destination sub-address field is the private Internet address if the address of the destination address field is the public Internet address of the receiving point, and performing a packet processing according to a pre-defined packet format if the address of the destination sub-address field is the private Internet address;
(e3) a step of exchanging the information of the destination address field with that of the destination sub-address field if the address of the destination sub-address field is not the private Internet address; and
(e4) a step of calculating the Internet protocol checksum and saving the calculated result, and forwarding the received packet to the public Internet.
